(19) United States
(12) Patent Application Publication
(10) Pub. No.: US 2018/0310550 A9
(43) Pub. Date: Nov. 1, 2018

(54) METHOD FOR PRODUCING PARTICLES COMPRISING A HYDROCARBON WAX IN A CONTINUOUS PHASE AND A PESTICIDE DISPERSED IN THE CONTINUOUS PHASE BY GENERATING DROPLETS WITH A VIBRATING NOZZLE

(71) Applicant: BASF SE, Ludwigshafen am Rhein (DE)

(72) Inventors: Joanna Mecfel-Marczewski, Limburgerhof (DE); Fabian Niedermair, Trostberg (DE); Mariano Etcheverry, Kiev (UA); Martina Schmitt, Boehl-Iggelheim (DE); Thomas Lichtenegger, Engelsberg (DE); John Frihauf, Lincoln, NE (US)

(21) Appl. No.: 15/567,406

(22) PCT Filed: Apr. 11, 2016
(86) PCT No.: PCT/EP2016/057871

§ 371 Date: Oct. 18, 2017

Related U.S. Application Data
(60) Provisional application No. 62/150,311, filed on Apr. 21, 2015.

(30) Foreign Application Priority Data
Apr. 27, 2015 (EP) 15165176.7

(51) Int. Cl. A01N 25/10; A01N 37/40; A01N 43/50

(52) U.S. Cl. CPC A01N 25/10; A01N 43/50; A01N 37/40

(57) ABSTRACT

Provided herein is a matrix particle comprising a hydrocarbon wax as matrix and a pesticide dispersed in the matrix. Also provided herein is a method for producing a matrix particle comprising a hydrocarbon wax as matrix and a pesticide dispersed in the matrix, where the method comprises the steps of a) providing a liquid premix comprising the hydrocarbon wax and the pesticide, b) generating droplets of the premix by a vibrating nozzle, and c) solidifying the droplets in a cooling medium. Further provided herein is a matrix particle obtained by the method, and a method of controlling phytopathogenic fungi, undesired plant growth, insect or mite attack, and for regulating the growth of plants, wherein the matrix particle is allowed to act on the respective pests, their environment, crop plants to be protected from the respective pest, the soil or undesired plants.

The present invention relates to a matrix particle comprising a hydrocarbon wax as matrix and a pesticide dispersed in the matrix; to a method for producing a matrix particle comprising a hydrocarbon wax as matrix and a pesticide dispersed in the matrix, where the method comprising the steps of a) providing a liquid premix comprising the molten hydrocarbon wax and the pesticide, b) generating droplets of the premix by a vibrating nozzle, and c) solidification of the droplets in a cooling medium; to a matrix particle obtained by said method; and to a method of controlling phytopathogenic fungi and/or undesired plant growth and/or undesired insect or mite attack and/or for regulating the growth of plants, wherein the matrix particle or the matrix particle obtainable by the method for producing the matrix particle are allowed to act on the respective pests, their environment or the crop plants to be protected from the respective pest, on the soil and/or on undesired plants and/or on the crop plants and/or on their environment. The present invention comprises combinations of preferred features with other preferred features.

Various particulate agrochemical formulations are known; as well as many agrochemical formulations which allow for a slow release of pesticides. There is an ongoing need to find agrochemical formulations which allow the overcome the drawbacks of known formulations.

The problem was solved by a matrix particle comprising a hydrocarbon wax as matrix and a pesticide dispersed in the matrix; and by a method for producing a matrix particle comprising a hydrocarbon wax as matrix and a pesticide dispersed in the matrix, where the method comprises the steps of

a) providing a liquid premix comprising the molten hydrocarbon wax and the pesticide,

b) generating droplets of the premix by a vibrating nozzle, and

c) solidification of the droplets in a cooling medium.

The matrix of the matrix polymer typically forms a continuous phase throughout the whole matrix particle. The matrix is usually evenly distributed throughout the whole matrix particle. The pesticide is dispersed in the matrix, which may mean that the pesticide is suspended, emulsified, and/or dissolved in the matrix. Preferably, the pesticide is dissolved and/or suspended in the matrix. Preferably, the pesticide is homogenously dispersed in the matrix.

The matrix particle may have any shape, such as a spherical shape, droplike or any asymmetric shape. The matrix particle may have preferably a spherical shape. Spherical shaped matrix particles may include not just those which are exactly spherical but also those matrix particles in which the maximum and minimum diameter of at least 90% (number average) of a representative sample differ by not more than 10%.

The matrix particle may have a particle size of 50 to 5000 μm, preferably of 100 to 2000 μm, and in particular of 300 to 600 μm. The particle size may be determined under a microscope by measuring single particles. The particle size may refer to the distance between the end of a particle, e.g. the diameter in a spherical shaped particle.

The hydrocarbon wax typically consists essentially of aliphatic hydrocarbons. In another form the hydrocarbon wax typically comprises at least 80 wt %, preferably at least 90 wt %, and in particular at least 95 wt % aliphatic hydrocarbons. The aliphatic hydrocarbons may be linear, branched or cyclic hydrocarbons, which may be saturated or unsaturated (preferably saturated).

The hydrocarbon wax may have a congealing point of at least 45° C., at least 50° C., at least 55° C., at least 58° C., at least 60° C., at least 62° C., or at least 64° C. The congealing point may be determined according to ASTM D938-12 (“Standard Test Method for Congealing Point of Petroleum Waxes, Including Petrolatum”).

The hydrocarbon wax may have a needle penetration of below 4,0 mm, preferably below 3,0 mm, in particular below 2,5 mm at 25° C. The congealing point may be determined according to DIN 51579 EN (“Testing of Paraffin; Determination of Needle Penetration”).

The hydrocarbon wax may have a viscosity at 100° C. of 1.0 to 20.0 mm²/s, preferably of 2.0 to 12.0 mm²/s, and in particular of 4.0 to 9.0 mm²/s. The viscosity may be determined according to ASTM D445.

The hydrocarbon wax may have an oil content of up to 5%, preferably of up to 3%, and in particular of up to 1,5%. The oil content may be determined according to ASTM D721.

In a preferred form the hydrocarbon wax comprises at least 80 wt % (preferably at least 90 wt %, and in particular at least 95 wt %) aliphatic hydrocarbons, which may be linear, branched or cyclic hydrocarbons and which may be saturated or unsaturated (preferably saturated), and where the hydrocarbon wax may have a congealing point of at least 45° C., at least 50° C., at least 55° C., at least 58° C., at least 60° C., at least 62° C., or at least 64° C.

A suitable hydrocarbon wax is macrocrystalline paraffin wax, microcrystalline paraffin wax, polyolefin wax, Fischer-Tropsch wax, or mixtures thereof. Such waxes are disclosed in detail by Wolfmeier et al. “Waxes” Ullmann's Encyclopedia of Industrial Chemistry, Wiley-VCH, 2000, Vol. 39, 111-172.

Macrocrystalline paraffin waxes (also called paraffin waxes) are obtainable from fossil oil derivatives, such as light and middle lubricating oil cuts of vacuum distillation. Macrocrystalline paraffin waxes usually consist predominantly (e.g. at least 50 wt %, preferably at least 60 wt %, and in particular at least 70 wt %) of mixtures of linear alkanes. Branched alkanes and cyclic alkanes may be present in the macrocrystalline paraffin waxes in amounts of up to 50 wt %, preferably up to 40 wt %, and in particular up to 30 wt %. The alkanes of the macrocystalline paraffin wax comprises usually a mixture of 018-045 alkanes.

Microcrystalline paraffin waxes (also called microwaxes) are obtainable from fossil oil derivatives, where they may be enriched in the vacuum residues (short residues) from lubricating oil distillation (residual waxes) or separate during the transportation and storage of crude oils (settling waxes). Microcrystalline paraffin waxes usually consist predominantly (e.g. at least 50 wt %, preferably at least 60 wt %, and in particular at least 70 wt %) of mixtures of saturated hydrocarbons that are predominantly solid at room temperature (such as n- and isoalkanes), naphthenes, and alkyl- and naphthene-substituted aromatics. Microcrystalline paraffin waxes usually consist predominantly (e.g. at least 50 wt %, preferably at least 60 wt %, and in particular at least 70 wt %) of mixtures of branched alkanes and napthenic compounds.

Fischer-Tropsch wax (also called Fischer-Tropsch paraffins) are obtainable by The Fischer-Tropsch synthesis by reaction of steam with natural gas or carbon. Fischer-Tropsch waxes usually consist predominantly of linear alkanes, which may have a chain length of 20 to 50 carbon atoms.

Polyolefin wax are usually obtainable by polymerization of ethylene. Suitable polyolefin waxes are polyethylene waxes. The molecular weight of the polyolefin wax (e.g. the polyethylene waxes) may be from 3000 to 20000 g/mol.

The particle comprises at least 50 wt %, preferably at least 60 wt %, and in particular at least 70 wt % of the hydrocarbon wax. The matrix particle comprises up to 99.5 wt %, preferably up to 99 wt %, and in particular up to 97 wt % of the hydrocarbon wax.

The term pesticide usually refers to at least one active substance selected from the group of the fungicides, insecticides, nematicides, herbicides, safeners, biopesticides and/or growth regulators. Preferred pesticides are fungicides, insecticides, herbicides and growth regulators. Especially preferred pesticides are herbicides. Mixtures of pesticides of two or more of the above-mentioned classes may also be used. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

The pesticide may be soluble or insoluble in water.

The pesticide may be liquid or solid at 20° C.

The pesticide may be soluble or insoluble in the hydrocarbon wax.

The matrix particle comprises up to 50 wt %, preferably up to 30 wt %, and in particular up to 15 wt % of the pesticide. The matrix particle comprises at least 0.5 wt %, preferably at least 1 wt %, and in particular at least 3 wt % of the hydrocarbon wax.

The amount of the hydrocarbon wax and the pesticide usually sums up to at least 90 wt %, preferably to at least 95 wt %, and in particular to at least 98 wt % of the total amount of the matrix particle.

In a preferred form the matrix particle comprises at least 50 wt % of the hydrocarbon, the amount of the hydrocarbon wax and the pesticide (e.g. a herbicide) sums up to at least 90 wt %, and the hydrocarbon wax has a congealing point of at least 45° C.

In another preferred form the matrix particle comprises at least 60 wt % of the hydrocarbon, the amount of the hydrocarbon wax and the pesticide (e.g. a herbicide) sums up to at least 95 wt %, and the hydrocarbon wax has a congealing point of at least 55° C.

In another preferred form the matrix particle comprises at least 70 wt % of the hydrocarbon, the amount of the hydrocarbon wax and the pesticide (e.g. a herbicide) sums up to at least 98 wt %, and the hydrocarbon wax has a congealing point of at least 60° C.

In another preferred form the matrix particle comprises at least 50 wt % of the hydrocarbon, the amount of the hydrocarbon wax and the pesticide (e.g. a herbicide) sums up to at least 90 wt %, the hydrocarbon wax has a congealing point of at least 45° C., and the hydrocarbon wax comprises at least 80 wt % aliphatic hydrocarbons (e.g. linear, branched or cyclic aliphatic hydrocarbons).

In another preferred form the matrix particle comprises at least 60 wt % of the hydrocarbon, the amount of the hydrocarbon wax and the pesticide (e.g. a herbicide) sums up to at least 95 wt %, the hydrocarbon wax has a congealing point of at least 55° C., and the hydrocarbon wax comprises at least 90 wt % aliphatic hydrocarbons (e.g. linear, branched or cyclic aliphatic hydrocarbons).

In another preferred form the matrix particle comprises at least 70 wt % of the hydrocarbon, the amount of the hydrocarbon wax and the pesticide (e.g. a herbicide) sums up to at least 98 wt %, the hydrocarbon wax has a congealing point of at least 60° C., and the hydrocarbon wax comprises at least 95 wt % aliphatic hydrocarbons (e.g. linear, branched or cyclic aliphatic hydrocarbons).

The matrix particle may be obtainable (preferably obtained) by the method according to the invention, such as the method comprising the steps of

a) providing a liquid premix of the molten hydrocarbon wax and the pesticide,

b) generating droplets of the premix by a vibrating nozzle, and

c) solidification of the droplets in a cooling medium.

The invention further relates to a method for producing a matrix particle comprising a hydrocarbon wax as matrix and a pesticide dispersed in the matrix, where the method comprising the steps of

d) providing a liquid premix comprising the molten hydrocarbon wax and the pesticide,

e) generating droplets of the premix by a vibrating nozzle, and

f) solidification of the droplets in a cooling medium.

The liquid premix may comprise the hydrocarbon was and the pesticide in a weight ratio of 40:60 to 99,1:0,1, preferably from 55:45 to 99,8:0,2, and in particular from 70:30 to 99,5:0,5.

The liquid premix may be provided at a temperature of at least 3° C., more preferably at least 5 ° C., and in particular at least 10° C., each above the congealing point of the hydrocarbon wax.

The liquid premix may be provided at a temperature of at least 45° C., more preferably at least 60° C., and in particular at least 70° C.

The premix is usually essentially free of solvents, such as organic solvents or water. The premix comprises usually less than 5 wt %, preferably less than 2 wt %, and in particular less than 0,5 wt % of solvents.

The generation of droplets of a liquid by a vibrating nozzle is known to an expert, e.g. from EP0467221A2. The vibrating nozzles are usually driven by electromagnetic oscillating systems, and by piezoelectric or magnetostrictive oscillating systems for very high frequencies (e.g. 30 to 300 Hz). With high throughputs, it is possible to use nozzle plates with up to 100 nozzles. The process of droplet formation from a vibrating liquid jet, including droplet formation into a sphere, takes usually place within very short periods from a few milliseconds up to a microsecond. The further fate of the round droplets, such as immediate solidification into spheres or the unwelcome formation of the so-called teardrop shape as a result of the effect of friction forces, and the unwelcome melting of the falling droplets into larger particles of every conceivable shape depends on the speed with which the droplets are solidified in this molten state.

In order to generate droplets of a liquid by a vibrating nozzle a device is usually used that comprises a supply container for the liquid premix, a nozzle head connected to a vibration generator and having one or more nozzles, a feed line between supply container and nozzle head, a drop distance for the droplets, a coolant supply unit and a collecting vessel for the matrix particles. The device may have a feed line for the liquid premix or a part thereof, the nozzle head, and a variable part of the drop distance above the coolant feed unit enclosed by a container having thermally insulating walls and having an aperture on its underside in the area of the drop distance. Suitable devices are commercially available, e.g. from BRACE GmbH, Germany.

The cooling medium can be both a gas, vapor or mist, or a liquid with as low a viscosity as possible. The droplets may come into contact with the cold cooling medium for the first time when they have assumed an exact spherical shape. This may be achieved by the cooling medium blowing laterally onto the droplets, but a more advantages method is cooling with the flow in the same direction. The cooling medium may have a temperature of up to 0° C., preferably up to −10° C., and in particular up to −20° C.

The solidified droplets may also be called the crude matrix particles, which may have various shapes. The crude matrix particles may be used without further workup for crop protection.

In another form the crude matrix particles are sieved to achieved a desired particle size. The method for producing the matrix particle may comprise the further step d) sieving of the solidified droplets.

The invention further relates to a method of controlling phytopathogenic fungi and/or undesired plant growth and/or undesired insect or mite attack and/or for regulating the growth of plants, wherein the matrix particle or the matrix particle obtainable by the method for producing the matrix particles are allowed to act on the respective pests, their environment or the crop plants to be protected from the respective pest, on the soil and/or on undesired plants and/or on the crop plants and/or on their environment. Preferably, the matrix particles are applied in dry form. Preferably, the matrix particles are applied on the soil. Preferably, the invention relates to a method of controlling undesired plant growth.

The matrix particles are also called the composition hereinafter.

The present invention also relates to a method of controlling undesired vegetation, which comprises allowing a herbicidal effective amount of the composition to act on plants, their habitat or on seed of said plants. In a preferred embodiment, the method may also include plants that have been rendered tolerant to the application of the agrochemical formulation wherein the anionic pesticide is a herbicide. The methods generally involve applying an effective amount of the agrochemical formulation of the invention comprising a selected herbicide to a cultivated area or crop field containing one or more crop plants which are tolerant to the herbicide. Although any undesired vegetation may be controlled by such methods, in some embodiments, the methods may involve first identifying undesired vegetation in an area or field as susceptible to the selected herbicide. Methods are provided for controlling the undesired vegetation in an area of cultivation, preventing the development or the appearance of undesired vegetation in an area of cultivation, producing a crop, and increasing crop safety. Undesired vegetation, in the broadest sense, is understood as meaning all those plants which grow in locations where they are undesired, which include but is not limited to plant species generally regarded as weeds.

In addition, undesired vegetation can also include undesired crop plants that are growing in an identified location. For example, a volunteer maize plant that is in a field that predominantly comprises soybean plants can be considered undesirable. Undesired plants that can be controlled by the methods of the present invention include those plants that were previously planted in a particular field in a previous season, or have been planted in an adjacent area, and include crop plants including soybean, corn, canola, cotton, sunflowers, and the like. In some aspects, the crop plants can be tolerant of herbicides, such as glyphosate, ALS-inhibitors, or glufosinate herbicides. The methods comprise planting the area of cultivation with crop plants which are tolerant to the herbicide, and in some embodiments, applying to the crop, seed, weed, undesired plant, soil, or area of cultivation thereof an effective amount of an herbicide of interest. The herbicide can be applied at any time during the cultivation of the tolerant plants. The herbicide can be applied before or after the crop is planted in the area of cultivation. Also provided are methods of controlling glyphosate tolerant weeds or crop plants in a cultivated area comprising applying an effective amount of herbicide other than glyphosate to a cultivated area having one or more plants that are tolerant to the other herbicide.

The term “herbicidal effective amount” denotes an amount of the pesticide, which is sufficient for controlling undesired vegetation and which does not result in a substantial damage to the treated plants. Such an amount can vary in a broad range and is dependent on various factors, such as the species to be controlled, the treated cultivated plant or material, the climatic conditions and the specific pesticidal active component used.

The term “controlling weeds” refers to one or more of inhibiting the growth, germination, reproduction, and/or proliferation of; and/or killing, removing, destroying, or otherwise diminishing the occurrence and/or activity of a weed and/or undesired plant.

The composition according to the invention has excellent herbicidal activity against a broad spectrum of economically important monocotyledonous and dicotyledonous harmful plants, such as broad-leaved weeds, weed grasses or Cyperaceae. The active compounds also act efficiently on perennial weeds which produce shoots from rhizomes, root stocks and other perennial organs and which are difficult to control. Specific examples may be mentioned of some representatives of the monocotyledonous and dicotyledonous weed flora which can be controlled by the composition according to the invention, without the enumeration being restricted to certain species. Examples of weed species on which the herbicidal compositions act efficiently are, from amongst the monocotyledonous weed species, Avena spp., Alopecurus spp., Apera spp., Brachiaria spp., Bromus spp., Digitaria spp., Lolium spp., Echinochloa spp., Leptochloa spp., Fimbristylis spp., Panicum spp., Phalaris spp., Poa spp., Setaria spp. and also Cyperus species from the annual group, and, among the perennial species, Agropyron, Cynodon, Imperata and Sorghum and also perennial Cyperus species. In the case of the dicotyledonous weed species, the spectrum of action extends to genera such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. Eclipta spp., Sesbania spp., Aeschynomene spp. and Viola spp., Xanthium spp. among the annuals, and Convolvulus, Cirsium, Rumex and Artemisia in the case of the perennial weeds.

Depending on the application method in question, the compositions according to the invention can additionally be employed in a further number of crop plants for eliminating undesirable plants. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Brassica juncea, Brassica campestris, Camellia sinensis, Carthamus tinctorius, Carya illinoinensis, Citrus limon, Citrus sinensis, Coffea arabica(Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays. Preferred crops are: Arachis hypogaea, Beta vulgaris spec. altissima, Brassica napus var. napus, Brassica oleracea, Brassica juncea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N.rustica), Olea europaea, Oryza sativa , Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

The compositions according to the invention can also be used in genetically modified plants. The term “genetically modified plants” is to be understood as plants, which genetic material has been modified by the use of recombinant DNA techniques in a way that under natural circumstances it cannot readily be obtained by cross breeding, mutations, natural recombination, breeding, mutagenesis, or genetic engineering. Typically, one or more genes have been integrated into the genetic material of a genetically modified plant in order to improve certain properties of the plant. Such genetic modifications also include but are not limited to targeted posttranstional modification of protein(s), oligo- or polypeptides e. g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, are particularly useful with the compositions according to the invention. Tolerance to classes of herbicides has been developed such as auxin herbicides such as dicamba or 2,4-D; bleacher herbicides such as hydroxyphenylpyruvate dioxygenase (HPPD) inhibitors or phytoene desaturase (PDS) inhibitors; acetolactate synthase (ALS) inhibitors such as sulfonyl ureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase (PPO) inhibitors; lipid biosynthesis inhibitors such as acetyl CoA carboxylase (ACCase) inhibitors; or oxynil (i. e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxin herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Examples of these herbicide resistance technologies are also described in US 2008/0028482, US2009/0029891, WO 2007/143690, WO 2010/080829, U.S. Pat. No. 6,307,129, U.S. Pat. No. 7,022,896, US 2008/0015110, U.S. Pat. No. 7,632,985, U.S. Pat. No. 7,105,724, and U.S. Pat. No. 7,381,861, each herein incorporated by reference.

Several cultivated plants have been rendered tolerant to herbicides by conventional methods of breeding (mutagenesis), e. g. Clearfield® summer rape (Canola, BASF SE, Germany) being tolerant to imidazolinones, e. g. imazamox, or ExpressSun® sunflowers (DuPont, USA) being tolerant to sulfonyl ureas, e. g. tribenuron. Genetic engineering methods have been used to render cultivated plants such as soybean, cotton, corn, beets and rape, tolerant to herbicides such as glyphosate, dicamba, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as ä-endotoxins, e. g. CrylA(b), CrylA(c), CrylF, CrylF(a2), CryllA(b), CrylllA, CrylllB(b1) or Cry9c; vegetative insecticidal proteins (VIP), e. g. VIP1, VIP2, VIP3 or VIP3A; insecticidal proteins of bacteria colonizing nematodes, e. g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be under-stood expressly also as pre-toxins, hybrid proteins, truncated or otherwise modified proteins. Hybrid proteins are characterized by a new combination of protein domains, (see, e. g. WO 02/015701). Further examples of such toxins or genetically modified plants capable of synthesizing such toxins are dis-closed, e. g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e. g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal pro-teins are, e. g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); New-Leaf® (potato cultivars producing the Cry3A toxin); Bt-Xtra®, NatureGard®, KnockOut®, BiteGard®, Protecta®, Bt11 (e. g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S. A., Belgium (corn cultivars producing the Cry3Bb1 toxin), IPC 531 from Monsanto Europe S. A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e. g. potato culti-vars, which express resistance genes acting against Phytophthora infestans derived from the mexican wild potato Solanum bulbocastanum) or T4-lyso-zym (e.g. potato cultivars capable of synthesizing these proteins with increased resistance against bacteria such as Erwina amylvora). The methods for producing such genetically modi-fied plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environ-mental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e. g. oil crops that produce health-promoting long-chain omega-3 fatty acids or unsaturated omega-9 fatty acids (e. g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Furthermore, it has been found that the compositions according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the compositions according to the invention.

As desiccants, the compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton. Moreover, a shortening of the time interval in which the individual cotton plants mature leads to an increased fiber quality after harvesting.

The compositions according to the invention are applied to the plants mainly by spraying the leaves. Here, the application can be carried out using, for example, water as carrier by customary spraying techniques using spray liquor amounts of from about 100 to 1000 I/ha (for example from 300 to 400 I/ha). The herbicidal compositions may also be applied by the low-volume or the ultra-low-volume method, or in the form of microgranules.

The herbicidal compositions according to the present invention can be applied pre- or post-emergence, or together with the seed of a crop plant. It is also possible to apply the compounds and compositions by applying seed, pretreated with a composition of the invention, of a crop plant. If the active compounds A and C and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

In a further embodiment, the composition according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compositions according to the invention. Here, the herbicidal compositions can be applied diluted or undiluted.

The term seed comprises seed of all types, such as, for example, corns, seeds, fruits, tubers, seedlings and similar forms. Here, preferably, the term seed describes corns and seeds.

The seed used can be seed of the useful plants mentioned above, but also the seed of transgenic plants or plants obtained by customary breeding methods.

The rates of application of the active compound are from 0.0001 to 3.0, preferably 0.01 to 1.0 kg/ha of active substance (a.s.), depending on the control target, the season, the target plants and the growth stage. To treat the seed, the pesticides are generally employed in amounts of from 0.001 to 10 kg per 100 kg of seed.

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha. In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required.

Various types of oils, wetters, adjuvants, fertilizer, or micronutrients, and other pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Further embodiments are as follows:
A1. A matrix particle comprising a hydrocarbon wax as matrix and a pesticide dispersed in the matrix.
A2. The matrix particle according to embodiment A1 comprising at least 50 wt % of the hydrocarbon wax.
A3. The matrix particle according to embodiments A1 or A2 where the amount of the hydrocarbon wax and the pesticide sums up to at least 90 wt % of the total amount of the matrix article.
A4. The matrix particle according to any of embodiments A1 to A3 where the amount of the hydrocarbon wax and the pesticide sums up to at least 95 wt % of the total amount of the matrix particle.
A5. The matrix particle according to any of embodiments A1 to A4 having a particle size of 50 to 5000 μm.
A6. The matrix particle according to any of embodiments A1 to A5 where the matrix particle has a spherical shape.
A7. The matrix particle according to any of embodiments A1 to A6 where the hydrocarbon wax consists essentially of aliphatic hydrocarbons.
A8. The matrix particle according to any of embodiments A1 to A7 where the hydrocarbon wax has a congealing point of at least 45° C.
A9. The matrix particle according to any of embodiments A1 to A8 where the hydrocarbon wax has a congealing point of at least 62° C.
A10. The matrix particle according to any of embodiments A1 to A9 where the hydrocarbon wax is selected from macrocrystalline paraffin wax, microcrystalline paraffin wax, polyolefin wax, Fischer-Tropsch wax, or mixtures thereof.
A11. The matrix particle according to any of embodiments A1 to A10 where the matrix particle is obtainable by a method comprising the steps of
   d) providing a liquid premix of the molten hydrocarbon wax and the pesticide,
   e) generating droplets of the premix by a vibrating nozzle, and
   f) solidification of the droplets in a cooling medium.

The present invention offers various advantages: The matrix particles enable a very slow release of the pesticide, even over several weeks; the matrix particles have a very low phytotoxicity, they are easy to apply, they are easy to prepare, even in industrial scale, they base on cheap hydrocarbon wax, which is commercially available in large scale; they can be applied without further formulations, e.g. simply the dry matrix particles may be applied; they have a constant release rate over several weeks; there is no wind drift during application; there is no leaching of the pesticide into the soil; there is no volatility of the pesticide; hydrophilic as well as hydrophobic pesticides can be used. The examples which follow illustrate the invention without imposing any limitation.

### EXAMPLES

### Example 1

### Dicamba

A liquid premix was prepared by melting 284 g of the Wax A and 71 g dicamba sodium at a temperature of 73° C. The liquid premix was fed into a vibrating nozzle unit (nozzle size 1000 μm, frequency 100 Hz, amplitude 1000 mV, pressure 50 mbar). In this unit, droplets of the liquid premix were formed and passed to a thermally conditioned fall tower under atmospheric pressure. Within the fall pipe a gentle nitrogen concurrent, thermally conditioned at about −30° C., was established. At the base of the tower the solid droplets were collected.

The crude matrix particles were presieved (2000 μm) and fine sieved (1000 μm and 500 μm). 141 g of waste and 45 g of matrix particles with a particle size from 500 to 1000 μm were obtained with a dicamba content of 5.63 wt %.

The Wax A is a hydrocarbon wax with a congealing point off 66-70° C. (ASTM D938-12), a needle penetration of 1.6-2.0 mm (25° C., DIN 51579 EN); viscosity at 100° C. of 6.0-8.0 mm2/s (ASTM D445); oil content of below 1% (ASTM D721); commercially available as Sasolwax® 6805 from Sasol Wax GmbH, Germany.

### Example 2

### Imazapyr

A liquid premix was prepared by melting a mixture of 99 wt % Wax A and 1 wt % imazapyr at a temperature of 73° C. The liquid premix was fed into a vibrating nozzle unit (nozzle size 500 μm, frequency 100 Hz, amplitude 1000 mV, pressure 450 mbar). In this unit, droplets of the liquid premix were formed and passed to a thermally conditioned fall tower under atmospheric pressure. Within the fall pipe a gentle nitrogen concurrent, thermally conditioned at about −30° C., was established. At the base of the tower the solid droplets were collected.

The crude matrix particles were presieved (2000 μm) and fine sieved (1000 μm and 500 μm). 3.1 kg of matrix particles with a particle size from 500 to 1000 μm were obtained with a imazapyr content of 1.0 wt %.

### Example 3

### Greenhouse Tests

In greenhouse tests soil containers were treated at the initial day with the dry matrix particles of Example 1 at an application rate for dicamba of 1000 g/ha or 2000 g/ha, respectively. Then the soil containers were covered with a plastic foil and stored in the greenhouse at ambient temperature. After 25, 32 or 39 days, respectively, weed (watercress, Nasturtium officinale) was sowed in the soil containers and cultivated for eight days. Then the efficacy of the dicamba on the weed was visually observed and rated (0%=no effect on weed, 100% weed completely depressed). The results were summarized in Tables 1 and 2.

For comparison, Clarity® herbicide from BASF containing 480 g/I dicamba in aqueous solution (SL formulation) was used.

The data showed that the matrix particles of the pesticide allow for a very long time of protection compared to the dissolved pesticide.

TABLE 1
Application rate 2000 g/ha

| Sowing after X days | dissolved pesticide | matrix particles |
|---|---|---|
| 25 | 90 | 85 |
| 32 | 65 | 90 |
| 39 | 0 | 85 |

TABLE 2
Application rate 1000 g/ha

| Sowing after X days | dissolved pesticide | Matrix particles |
|---|---|---|
| 25 | 30 | 75 |
| 32 | 0 | 70 |
| 39 | 0 | 80 |

1. A method for producing a matrix particle comprising a hydrocarbon wax as matrix and a pesticide dispersed in the matrix, wherein the method comprises:
a) providing a liquid premix comprising the hydrocarbon wax and the pesticide,
b) generating droplets of the premix by a vibrating nozzle, and
c) solidifying the droplets in a cooling medium.

2. The method according to claim 1, wherein the premix is substantially free of solvents.

3. The method according to claim 1, wherein the matrix particle comprises at least 50 wt % of the hydrocarbon wax.

4. The method according to claim 1, wherein an amount of the hydrocarbon wax and the pesticide sums up to at least 90 wt % of a total amount of the matrix particle.

5. The method according to claim 4, wherein the amount of the hydrocarbon wax and the pesticide sums up to at least 95 wt % of the total amount of the matrix particle.

6. The method according to claim 1, wherein the matrix particle has a particle size of 50 to 5000 μm.

7. The method according to claim 1, wherein the matrix particle has a spherical shape.

8. The method according to claim 1, wherein the hydrocarbon wax comprises aliphatic hydrocarbons.

9. The method according to claim 1, wherein the hydrocarbon wax has a congealing point of at least 45° C.

10. The method according to any claim 9, wherein the hydrocarbon wax has a congealing point of at least 62° C.

11. The method according to any claim 1, wherein the hydrocarbon wax is selected from the group consisting of macrocrystalline paraffin wax, microcrystalline paraffin wax, polyolefin wax, Fischer-Tropsch wax, and mixtures thereof.

12. A matrix particle comprising a hydrocarbon wax as matrix and a pesticide dispersed in the matrix, wherein the matrix particle is produced by
providing a liquid premix comprising the hydrocarbon wax and the pesticide,
generating droplets of the premix by a vibrating nozzle, and
solidifying the droplets in a cooling medium.

13. A method of controlling at least one of phytopathogenic fungi, undesired plant growth, undesired insect attacks, and undesired mite attacks, or for regulating the growth of plants, the method comprising:
providing a liquid premix comprising a hydrocarbon wax and a pesticide;
generating droplets of the premix by a vibrating nozzle;
solidifying the droplets in a cooling medium to create a matrix particle; and
applying the matrix particles on at least one of the respective pests, their environment, the crop plants to be protected from the respective pest, on the soil, on undesired plants, on the crop plants, and on their environment.
